(19) United States
(12) Patent Application Publication
(10) Pub. No.: US 2026/0118475 A1
(43) Pub. Date: Apr. 30, 2026

(54) Operation method of a target detection radar in a mode of maritime surveillance and associated detection radar

(71) Applicant: THALES, Meudon (FR)

(72) Inventors: Philippe GOY, MERIGNAC (FR); Rodolphe COTTRON, MERIGNAC (FR); Stéphane KEMKEMIAN, MERIGNAC (FR)

(21) Appl. No.: 19/367,836

(22) Filed: Oct. 24, 2025

(30) Foreign Application Priority Data
Oct. 25, 2024 (FR) 2411679

(51) Int. Cl. G01S 7/35; G01S 7/02; G01S 7/41; G01S 13/88

(52) U.S. Cl. CPC G01S 7/354; G01S 7/024; G01S 7/414; G01S 13/88

(57) ABSTRACT

The present invention relates to a method of operating a target detection radar in a mode of maritime surveillance. The method includes determining a level of false alarms in each geographical sector, implementing several recurrences of a signal emission/reception operation, for each geographical sector, of a type chosen from simple waves and communal waves, based on the level of false alarms determined for at least one of the geographical sectors. Each communal wave includes at least two consecutive pulses associated with different emission directions and/or different frequencies, and emitted in different frequency bands. Each simple wave includes a single pulse.

### REFERENCE TO RELATED APPLICATIONS

This application is a U.S. non-provisional application claiming the benefit of French Patent Application No. 24 11679 filed on Oct. 24, 2024, the contents of which are incorporated herein by reference in their entirety.

### TECHNICAL FIELD OF THE INVENTION

The present invention relates to an operation method of a target detection radar in a mode of maritime surveillance.

The present invention also relates to a detection radar implementing such a method.

The technical field of the invention is that of radar systems embarked on aircraft, ships, submarines, or satellites, for example, implementing target detection/identification in a maritime surveillance mode.

The general problem solved by the invention is to remedy the stroboscopic effect of wave fronts to readjust the extraction processing “turn-by-turn” while maintaining or locally reducing the radar detection balance.

### BACKGROUND OF THE INVENTION

In the context of a maritime surveillance mode, where the detection criterion is mostly (or solely) in the presence of strong sea clutter, i.e., for distances close to the radar, increasing the radar balance by coherent processing is not an appropriate solution to improve target detection, unlike the case of the presence of only thermal noise.

In this context, opting for a large pulse width to increase the pulse compression gain or opting for a longer observation time to increase the Doppler processing gain in Doppler mode is not necessarily an advantageous strategy.

When the clutter-to-noise ratio (called CNR) is very high, at short distances, for example, the detection of small maritime targets is hindered by the presence of spikes, i.e., clutter echoes with a high equivalent radar surface (also called RCS “Radar Cross Section”) as compared to an average equivalent radar cross section of the local clutter. Waves can be the cause of such a phenomenon, for example.

To differentiate a target from a spike, which do not have the same correlation time, “turn-by-turn” (or scan-to-scan) type extractors or even kinematic filtering are generally used to extract the contributions of targets and surrounding spikes over time.

For this, it is assumed that the spikes will “collapse” in power more quickly than the coherence time of the targets, which is assumed to be higher. This is why “K/N” type extractors are generally used to filter out false alarms related to spikes.

However, these “turn-by-turn” type processes assume that the contributions of spikes in a “distance-azimuth” type macro-cell are not replaced by other contributions. But under atypical clutter conditions, this is not always the case: for high wave speeds, new physical contributions can migrate and replace the previous ones, undermining the extraction processing.

### SUMMARY OF THE INVENTION

The present invention aims to remedy this problem and improve the quality of maritime target detection even under atypical clutter conditions.

To this end, the invention aims at a method of operating a target detection radar in a maritime surveillance mode, with the detection radar implementing a scan in a plurality of geographical sectors;
the method including determining a false alarms level in each geographical sector;
the method further including implementing several recurrences of an operation of signal emission/reception, for each geographical sector, of a type chosen from simple waves and communal waves, based on the false alarms level determined for at least one of the geographical sectors;
each communal wave including at least two consecutive pulses associated with different emission directions and/or different frequencies, and emitted in different frequency bands;
each simple wave including a single pulse.

According to other advantageous aspects of the invention, the method includes one or more of the following features, taken individually or in any technically possible combination:
the communal waves are chosen in a geographical sector when the false alarms level in at least one of the geographical sectors is above a predetermined threshold;
the method further includes adapting, in at least one of the geographical sectors, based on the false alarms level, at least one of the parameters chosen from the group including:
   an observation time of each pointing position in this geographical sector or in another geographical sector;
   a target extraction threshold in this geographical sector;
   a number of pulses emitted in each communal wave in this geographical sector or in another geographical sector;
the geographical sector in which the communal waves are chosen is chosen randomly or according to a predetermined rule, among all the geographical sectors whose number of false alarms has not exceeded the threshold;
each geographical sector corresponds to a quadrant describing the sea clutter based on the wind;
each quadrant corresponds to a “downwind”, “upwind”, and “crosswind” type domain;
a false alarm is determined by applying a target density criterion per zone and/or by analyzing the number of targets in a zone according to external data;
the method further includes analyzing the received signal echoes including a “turn-by-turn” type of extraction processing;
each n^{th} recurrence of the operation of emission/reception of communal waves incudes:
   generating at least two consecutive pulses associated with different emission directions and/or different frequencies;
   emitting the pulses in different frequency bands;
   receiving echoes of the pulses in a common time window;
each pulse is emitted with a random phase associated with the corresponding frequency band;
the receiving includes compensating the phase shift of the received echoes in each frequency band by the random phase associated with this frequency band;
during the emitting, the corresponding pulses are emitted using different chirp slopes used to emit them;
during the receiving, echoes associated with different emission directions and/or frequencies are distinguished by determining the slopes of the corresponding chirps;
during the emitting, the corresponding pulses are emitted using different polarizations;
during the receiving, echoes associated with different emission directions and/or frequencies are distinguished by determining their polarizations;
a polarization is emitted for each pulse, or a set of polarizations forming a signature is emitted for each pulse.

The invention also aims at a target detection radar including technical means configured to implement the method as defined above.

### BRIEF DESCRIPTION OF THE DRAWINGS

The invention will appear more clearly upon reading the following description, given solely by way of non-limiting example, and made with reference to the drawings in which:

FIG. 1 is a schematic view of a detection radar according to the invention;

FIG. 2 is a flowchart of a radar operation method of FIG. 1; and

FIGS. 3 and 4 are different views illustrating the implementation of the method of FIG. 2.

### DETAILED DESCRIPTION OF THE INVENTION

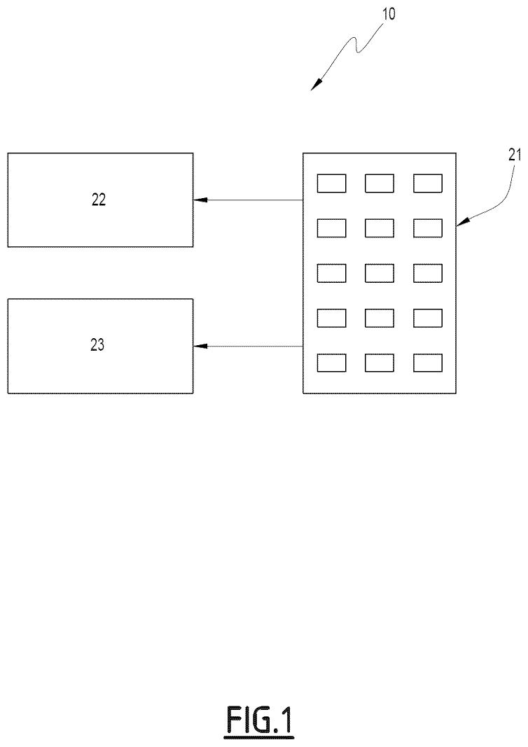

FIG. 1 illustrates a detection radar 10 according to the invention. This radar 10 is intended to be embarked on a mobile carrier moving in the air and/or on a terrestrial surface and/or on a maritime surface, for example. Advantageously, the radar 10 is intended to be embarked on a carrier moving in the air, such as an aircraft. Alternatively, the radar 10 is arranged in a fixed manner.

The radar 10 enables detecting targets following a maritime surveillance mode such as a Doppler mode of the MMTI type (“Maritime Moving Target Indicator”) or a non-Doppler mode.

With reference to FIG. 1, the radar 10 includes an array of elementary antennas 21 enabling emission of signals in the form of pulses and reception of signals corresponding to echoes of these pulses.

The radar 10 further includes an emission unit 22 enabling the generation of pulses to be emitted by the antenna array 21 and a reception unit 23 enabling the processing of echoes received by the antenna array 21, to deduce the presence of a target and, possibly, a speed and a distance to this target.

Each of the units 22, 23 is made in the form of a programmable circuit of the FPGA type (“Field Programmable Gate Array”) and/or of the ASIC type (“Application-Specific Integrated Circuit”), for example. In addition, or in a variant, each of these units 22, 23 is made at least partially in the form of software executable by a processor and stored in a memory.

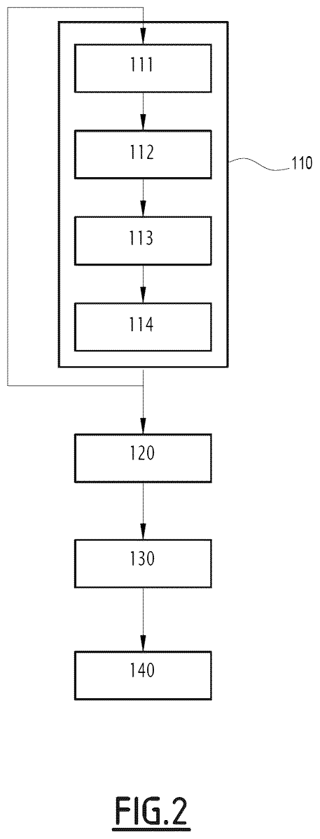

The operation method of the radar 10 will now be explained with reference to FIG. 2 presenting a flowchart of its steps.

It is considered that this method is implemented during an electronic scan of the space around the radar 10. In particular, this method includes the iterative implementation of at least operations 110 and 120 described below for each pointing position of the radar 10. Each iteration of these operations is called a recurrence.

It is further considered that the pointing positions succeed each other according to a predetermined turn direction and all define an angular opening dependent on the pointing angle, already known to the skilled person. The set of pointing positions covers the entire available visibility cone of the radar system. Without being limiting for the invention, this cone forms a 360° turn, for example. In addition, an observation time Tr(i) is defined for each pointing position. This observation time corresponds to the measurement time in the corresponding pointing position.

The time elapsed between two successive measurements in the same pointing position is called the refresh time T_{raf}.

The calculation of this refresh time T_{raf} depends on the mode chosen for the radar 10.

In particular, for a non-Doppler mode:

$${T}_{raf} = {\sum }_{i = 1}^{{Nb}_{p}} {Nb}_{fe} ( i ) \times Tr ( i )$$

where
Nb_{fe}(i) is the number of different frequencies to be emitted in a pointing direction to perform non-coherent integration (power averaging); and
Nbₚ(i) is the number of pointings.

For a Doppler mode, the previous formula takes the following form:

$${T}_{raf} = {\sum }_{i = 1}^{{Nb}_{p}} {Nb}_{fe} ( i ) \times {N}_{rec} ( i ) \times Tr ( i )$$

where
N_{rec}(i) is the number of recurrences processed coherently for the same frequency.

Each pointing position belongs to a geographical sector defined based on the environment in which the radar 10 operates. For example, four sectors, then called quadrants, may be determined around the radar 10 based on the wind. Each sector may thus correspond to a geographical zone of the “downwind”, “upwind”, and “crosswind” type. Alternatively, the geographical sectors are defined more finely and, possibly, irregularly. Their number may thus be strictly greater than 4. In general, the number of geographical sectors is greater than or equal to 1.

Advantageously, a plurality of successive pointing positions corresponds to the same sector.

Each n^{th} recurrence of operation 110 includes an emission/reception of signals in the corresponding pointing position.

In particular, during this operation, the emission unit 22 of the radar 10 emits signals in a cone defined by the pointing position and the reception unit 23 receives echoes of these signals.

This signal emission/reception operation 110 includes several sub-operations, whose implementation depends on the type of signals chosen. These sub-operations will be explained in detail later. This operation 110 also includes filtering and detection processing, as will be explained later.

During each n^{th} recurrence of the following operation 120, the radar 10 and specifically its reception unit 23 implement an analysis of the received signals. In particular, this operation 120 includes a “turn-by-turn”type extraction processing, enabling the identification of maritime targets.

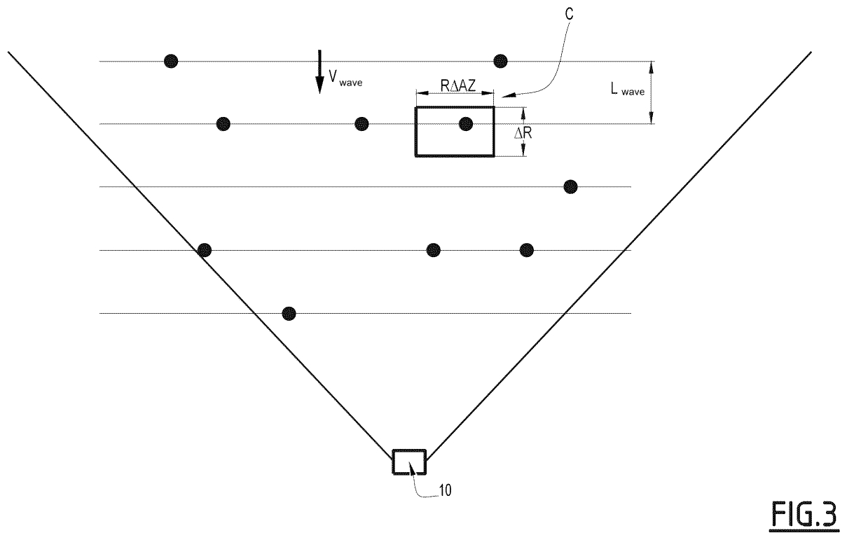

As already known per se, such processing is carried out by considering a plurality of macro-cells likely to contain a maritime target. An example of such a macro-cell C is illustrated in FIG. 3.

In particular, this FIG. 3 illustrates an arrangement of an antenna panel of the radar 10 facing wave fronts, illustrated in this figure by horizontal lines. The set of waves forms a wave train moving at speed V_{wave} and having a gap L_{wave} between the waves. In the figure, the macro-cell C is of size (ΔR, RΔAz), where the values ΔR and RΔAz correspond to processing resolutions in distance and in azimuth, respectively. The extraction processing related to this macro-cell is of duration NxT_{raf}, where T_{raf} corresponds to the refresh time assumed constant between two measurements and N corresponds to the number of measurements, i.e., the number of implementations of operation 110 in the same pointing position.

A maritime target is considered detected when, at the end of the analysis of the macro-cell C, the radar 10 concludes that such a target is present in the macro-cell.

A maritime target is considered definitively detected when, after several implementations of operations 110 and 120, at least K detections are present and correlate in the same macro-cell over a horizon of N implementations of these operations. In this notation, the number K denotes the number of operations 120 during which the target was considered detected. The coefficient K/N can then be compared with a threshold, called the target extraction threshold.

During a subsequent operation 130, implemented at least once per turn of the radar 10, the radar 10 determines the false alarms level generated in each geographical sector. In particular, “false alarm” is understood as any plot taken from the detection and extraction processing that does not come from a useful target from the radar operator's point of view (such as noise peak, clutter spikes, etc.).

For this, the radar 10 verifies that each detection extracted does indeed correspond to a target of interest present in the corresponding sector by using a complementary processing other than that implemented during step 120.

This complementary processing may include the implementation of a target density criterion per zone (distance, azimuth) or even a comparison of a number of maritime vessels on site declared by an automatic identification system of the “AIS” type (“Automatic Identification System”) in view of the radar plot density.

A detection is confirmed when this complementary processing confirms the presence of a target of interest and is considered an otherwise false alarm.

During a subsequent operation 140, implemented at least once per turn, the radar 10 compares the number of false alarms with a predetermined threshold for each sector.

When this number is below the threshold for all sectors, the next recurrence of operations 110 and 120 is implemented in relation to the next sector, with the same parameters as previously.

Otherwise, if the threshold is exceeded for at least one of the sectors, the parameters are readjusted on at least one pointing to be carried out for a complete turn.

This readjustment mainly aims to reduce the refresh time T_{raf}.

Indeed, as indicated previously, a set of false alarms may be mainly due to the stroboscopic phenomenon of waves during the extraction processing implemented during step 120.

To avoid such a phenomenon, a wave front must not replace the next one in the same macro-cell. This is true when the following two conditions are met:
1) There is at most only one wave front per macro-cell: ΔR<L_{wave}.
2) The displacement of a wave front does not exceed the gap between two fronts: V_{wave}×N×T_{raf}<L_{wave}.

Condition 2) is to be reproduced for the different viewing angles α; it is to be considered in terms of radial speed vis-à-vis the radar 10, i.e., replacing V_{wave} by its projection V_{wave} cos(α)<V_{wave}.

A solution consisting of reducing ΔR enables meeting the first condition but not the second. Moreover, this ΔR reduction also decreases the maximum observable speed of the targets. In addition, in practice, L_{wave} and V_{wave} are unknown and on atypical clutter for high wave speed and a small wavelength. Thus, to be able to verify the second condition, the refresh time T_{raf} must be decreased.

Thus, according to a first embodiment, during operation 140, the radar 10 decreases the observation times of all pointing of at least one sector. This decreases the refresh time T_{raf} of the complete turn.

This is possible by accelerating the electronic scan implemented by the radar 10, for example, i.e., by decreasing the number of recurrences emitted in one direction.

The choice of the sector in which the observation times must be decreased may be made according to different implementation examples.

According to a first example, the chosen sector is the one in which the number of false alarms has exceeded the threshold.

According to a second example, on the contrary, this sector is chosen randomly, at least initially, for example, and according to a predetermined rule, among all the sectors whose number of false alarms has not exceeded the threshold.

Then, the “trial/error” principle may be applied during the following iterations of the method to confirm or modify this choice.

For example, when this choice has enabled reducing the number of false alarms in the corresponding sector, the choice of the same sector may be kept for a following iteration of the method operations.

Conversely, when this choice has not enabled reducing the number of false alarms, another sector is chosen during a following iteration of the method steps.

Alternatively, or optionally, the radar adapts the target extraction threshold for at least one given sector to reduce the number of false alarms. Here, it may be the sector whose number of false alarms has exceeded the threshold.

According to a second embodiment, combinable with the first embodiment, the radar 10 adapts the type of signals emitted/received during operation 110.

In particular, it is initially considered that the signals emitted/received during oeration 110 are of the so-called simple wave type.

In such a case, this operation 110 includes a sub-operation 111 of generating a pulse, a sub-operation 112 of emitting this pulse in a predetermined frequency band, a sub-operation 113 of receiving an echo of this pulse in a time window of predetermined duration, and a sub-operation 114 of pre-processing the received echoes including, for example, an adapted filtering and an adapted detection processing (for example in power or contrast).

When the false alarms level is too high in a sector, the radar 10 modifies the type of signals emitted/received during operation 110 to the so-called communal wave type, at least in one sector. The choice of such a sector may be made according to the same principle as that described previously. In particular, this chosen sector may correspond to the sector having the level of false alarms above the threshold or, on the contrary, to a sector chosen randomly or according to a predetermined rule among all the sectors whose number of false alarms has not exceeded the threshold. The “trial/error” principle may also be applied for the following iterations.

Each communal wave includes at least two consecutive pulses associated with different emission directions and/or different frequencies, and emitted in different frequency bands. Advantageously, the communal wave enables accelerating the electronic scan without modifying the number of recurrences transmitted in one direction.

In such a case, during sub-operation 111, the emission unit 22 of the radar 10 generates two consecutive pulses associated with different frequencies or different emission directions.

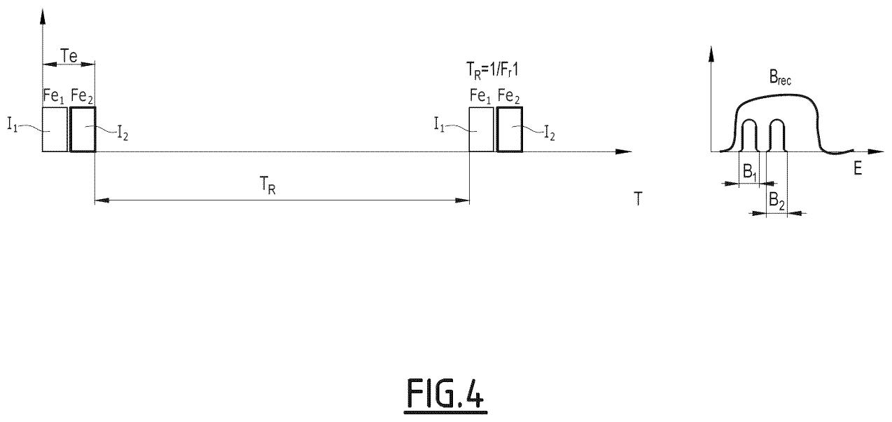

In particular, during this sub-operation, the emission unit 22 generates a first pulse I₁ and a second pulse I₂, illustrated in FIG. 4.

Each pulse is associated with a particular frequency or a particular emission direction. This emission direction may be defined by a pair of angular values, for example. These angular values correspond to the elevation (or site) and the emission azimuth, for example, denoted hereafter by Elᵢ and Azᵢ, respectively. In all that follows, the index i=1 designates any value relative to the first pulse, and i=2 designates any value relative to the second pulse.

The pulses are generated in an emission window Te in which each pulse has a width Li and is spaced from the other pulse and from one of the boundaries of the emission window Te by a time gap T_{GAP}.

In the frequency domain, the pulses share the same frequency support B_{rec}, with a frequency gap F_{GAP} between the corresponding carriers Fi greater than the frequency bands Bi of these pulses. The frequency gap F_{GAP} is chosen as sufficient to distinguish the echoes of these pulses upon reception. In all that follows, a frequency band is defined by a central frequency and a bandwidth. Advantageously, in the following, all frequency bands have the same width. In addition, the frequency gap F_{GAP} is measured between a pair of corresponding central frequencies and is greater than the width of each frequency band.

The frequency bands B₁ and B₂ of the first pulse I₁ and the second pulse I₂, respectively, are advantageously chosen as the same for each recurrence of step 110. Thus, the same central frequency Fe₁ and the same central frequency Fe₂ are chosen for the respective first and second pulse in each recurrence of operation 110.

During sub-operation 112, the emission unit 22 emits the pulses generated during the previous sub-operation in the corresponding frequency bands.

During sub-operation 113, the reception unit 23 receives echoes corresponding to the emitted pulses in a common reception time window. The duration Tr of this common reception window is equal to the total duration of the recurrence T_{R} (i.e., the observation time of the corresponding pointing for a recurrence, as defined previously) minus the duration of the emission window Te. During reception, the echoes corresponding to different pulses are distinguished by their different frequency bands, using band-pass filters, for example. A spatial filtering of the FFC type may also be applied in the direction associated with the band.

Of course, the number of pulses emitted during sub-operation 111 may be greater than 2 and may also have an adjustment parameter during operation 140 for the corresponding geographical sector. This then enables further reducing the refresh time. Advantageously, in one embodiment, the communal wave uses the same number of recurrences transmitted in a direction by the simple wave form. This implies the use of the same post-integration number, or even the same number of recurrences, for Doppler processing. At least two directions acting at the same time enables reducing the refresh time.

In addition, when it is no longer necessary to track targets in a given geographical sector, for example, the radar 10 may again readjust the parameters used during operations 110 and 120 for the or each corresponding sector, by lengthening the refresh time. For this, simple wave type signals may then be used in this/these sector(s).

During sub-operation 114, the reception unit 23 performs a pre-processing of the received echoes including an adapted filtering and an adapted detection processing (such as in power or contrast), for example.

The results of such pre-processing are used as inputs for operation 120.

It is then understood that the method according to the invention enables improving the quality of maritime target detection even under atypical clutter conditions, specifically by reducing the level of false alarms. This is done by adapting the observation times specifically in at least one geographical sector (and consequently the overall refresh time) and possibly other parameters used for signal processing. The emission of communal wave type signals is particularly advantageous as it enables covering several frequencies and/or directions at once.

In some embodiments, the operation method as explained above further includes implementation of at least one technique enabling separating the echoes of pulses corresponding to different frequencies/directions, during the emission/reception of communal waves, and/or rejecting the consideration of certain echoes that are unnecessary or are ambiguous in distance to reconstruct a complete image of the environment.

According to a first technique, usable for a Doppler mode, during implementation of the n^{th} recurrence of operation 110 and specifically during the emission sub-operation 112, the emission unit 22 chooses one of the pulses, such as the first pulse, and adds a random phase φᵢₙ to this pulse. Advantageously, the emission unit 22 adds a different random phase φᵢₙ to each of the pulses. The or each pulse having a random phase φᵢₙ added is hereafter called a de-phased pulse.

It should be noted that the choice of the pulse to de-phase may remain the same for each recurrence of this sub-operation 112. In other words, when only one pulse is de-phased during this sub-operation, the same pulse is de-phased in each recurrence of this operation. When both pulses are de-phased during this sub-operation, these pulses are also de-phased in each recurrence of this sub-operation.

Then, during the reception sub-operation 113, the reception unit 23 compensates for the dephasing of the received echoes in the frequency band of the or each de-phased pulse by the corresponding random phase. In other words, the dephasing is carried out by subtracting the value φᵢₙ the band corresponding to the index i.

Thus, during the subsequent processing, only the echoes corresponding to a corresponding direction/frequency can be processed coherently. The dephasing of other echoes cannot be done correctly, so that they are considered as white noise.

Other techniques to obtain better isolation of echoes corresponding to different frequencies/directions during their reception are also possible.

Thus, according to a second technique, usable for Doppler and non-Doppler modes, during implementation of the n^{th} recurrence of operation 110 and specifically during the emission sub-operation 112, the emission unit 22 implements different slopes of the chirps used to emit the pulses associated with different frequencies/directions. In other words, during this sub-operation 112, the emission unit 22 emits the pulses using either an ascending slope or a descending slope, depending on the frequency/direction associated with each pulse. The same slope is then used for all pulses of this type in all recurrences of step 110.

For example, for all recurrences, an ascending slope is chosen for pulses associated with a particular frequency/direction, and a descending slope is chosen for pulses associated with another particular frequency/direction.

Then, during the reception sub-operation 113, the reception unit 23 receives echoes having different frequency slopes. This reception unit 23 thus determines the received slopes (specifically by using adapted filters) to isolate the echoes corresponding to different frequencies/directions.

According to a third technique, usable for Doppler and non-Doppler modes and also enabling better isolation of echoes corresponding to different frequencies/directions during their reception, during the implementation of the n^{th} recurrence of operation 110 and specifically during the emission sub-operation 112, the emission unit 22 implements different polarizations of the waves used to emit the pulses associated with different frequencies/directions. In other words, during this sub-operation 112, the emission unit 22 emits the wave carrying each pulse with a polarization chosen based on the frequency/direction associated with this pulse. This same polarization is chosen for this type of pulse for all recurrences of operation 110.

For example, two polarizations, namely a vertical polarization and a horizontal polarization, may be chosen for the pulses emitted during sub-operation 112. According to other examples, a 45° or circular polarization may be used.

Then, during the reception sub-operation 113, the reception unit 23 receives echoes having different polarizations. This reception unit 23 thus determines the polarizations of the received echoes (specifically by using adapted filters) to isolate the echoes corresponding to different frequencies/directions.

The principle just described may be refined by using several polarizations in the same pulse.

In such a case, each pulse includes a specific polarization signature. Such a signature corresponds to a polarization code.

This technique thus enables coloring the different pulses in space and obtaining an additional rejection of 20 to 30 dB.

In some embodiments, the above techniques are combined with each other to be implemented simultaneously. In addition, a technique to resolve ambiguities in distance and speed and/or according to at least one pointing direction may also be used in combination with the second technique or the third technique, as described above.

1. A method of operating a target detection radar in a mode of maritime surveillance, the detection radar implementing a scan in a plurality of geographical sectors, the method comprising;
determining a level of false alarms in each geographical sector; and
implementing several recurrences of an operation of signal emission/reception, for each geographical sector, of a type chosen from simple waves and communal waves, based on a level of false alarms determined for at least one of the geographical sectors, each communal wave comprising at least two consecutive pulses associated with different emission directions and/or different frequencies, and emitted in different frequency bands, and each simple wave comprising a single pulse.

2. The method according to claim 1, wherein the communal waves are chosen in a geographical sector when the level of false alarms in at least one of the geographical sectors is above a predetermined threshold.

3. The method according to claim 2, wherein the geographical sector in which the communal waves are chosen is chosen randomly or according to a predetermined rule, among all the geographical sectors whose number of false alarms has not exceeded the threshold.

4. The method according to claim 1, further comprising adapting, based on the level of false alarms in at least one of the geographical sectors, of at least one of the parameters chosen from the group comprising:
an observation time of each pointing position comprised in this geographical sector or in another geographical sector;
a target extraction threshold in this geographical sector; and
a number of pulses emitted in each communal wave in this geographical sector or in another geographical sector.

5. The method according to claim 1, wherein each geographical sector corresponds to a quadrant describing the sea clutter based on the wind.

6. The method according to claim 5, in which each quadrant corresponds to a “downwind”, “upwind” and “crosswind” type domain.

7. The method according to claim 1, wherein a false alarm is determined by applying a target density criterion per zone and/or by analyzing the number of targets in a zone according to external data.

8. The method according to claim 1, further comprising analyzing the received signal echoes comprising a “turn-by-turn” type extraction processing.

9. The method according to claim 1, wherein each n^{th} recurrence of operation of emission/reception of communal waves comprises:
generating at least two consecutive pulses associated with different emission directions and/or different frequencies;
emitting the pulses in different frequency bands; and
receiving echoes of the pulses in a common time window.

10. The method according to claim 9, wherein each pulse is emitted with a random phase associated with the corresponding frequency band, and said receiving comprises compensating the phase shift of the received echoes in each frequency band by the random phase associated with this frequency band.

11. The method according to claim 9, wherein: during said emitting, the corresponding pulses are emitted using different chirp slopes used to emit them, and during said receiving, echoes associated with different emission directions and/or frequencies are distinguished by determining slopes of the corresponding chirps.

12. The method according to claim 9, wherein during said emitting, the corresponding pulses are emitted using different polarizations, and during said receiving, echoes associated with different emission directions and/or frequencies are distinguished by determining their polarizations.

13. The method according to claim 12, comprising emitting, for each pulse, a polarization or a set of polarizations forming a signature.

14. A target detection radar comprising:
an array of elementary antennas;
an emission unit; and
a reception unit,
said emission unit and said reception unit configured to implement the method according to claim 1.
